(19) United States
(12) Patent Application Publication
(10) Pub. No.: US 2006/0220368 A1
(43) Pub. Date: Oct. 5, 2006

(54) Seatbelt apparatus

(75) Inventors: Masato Takao, Tokyo (JP); Koji Tanaka, Tokyo (JP); Koji Inuzuka, Tokyo (JP)

Correspondence Address: FOLEY AND LARDNER LLP;SUITE 500, 3000 K STREET NW, WASHINGTON, DC, 20007, US

(73) Assignee: TAKATA CORPORATION

(21) Appl. No.: 11/389,280

(22) Filed: Mar. 27, 2006

(30) Foreign Application Priority Data
Mar. 31, 2005 (JP) 2005-105419

(51) Int. Cl. B60R 22/00; B65H 75/48; A62B 35/00

(52) U.S. Cl. 280/801.1; 280/807; 242/390.8; 297/477

(57) ABSTRACT

A seatbelt retractor may include a spool for retracting and withdrawing a seatbelt, an electric motor, and a power transmission mechanism for enabling the spool to retract and withdraw the seatbelt by transmitting power of the electric motor to the spool. The seatbelt retractor may also include a control device for switching the states of the power transmission mechanism between a power transmitting-state wherein the spool rotates and a power transmission released-state. The power transmitting-state may be released by switching the rotating directions of the electric motor.

### BACKGROUND

The present invention relates to the structure of a seatbelt retractor mounted on a motor vehicle.

A seatbelt apparatus may be configured to protect an occupant seated on a motor vehicle seat by a seatbelt (or webbing), which keeps the occupant under restraint. For example, Japanese PCT Publication No. 2003-507252 discloses a seatbelt retractor configuration in a seatbelt apparatus for performing the retracting and withdrawing operations of a seatbelt by rotating a spool (or the retracting shaft) by an electric motor.

In addition, a seatbelt retractor that has a configuration for switching power transmitting states is also known. For example, this switching could be from a power transmitting state to a power transmission released-state and vice versa. The power transmitting state is a state in which the power of an electric motor is transmitted to the spool via a clutch-type power transmission mechanism by rotating the electric motor. The power transmission released-state is one in which the power transmitting state is released.

When the aforementioned seatbelt retractor is designed, there is a high demand for increasing the reliability at the time of the releasing operation for the power transmitting operation while paying attention to the power transmitting state of the power transmission mechanism. In particular, in a case when the power transmitting state of the power transmission mechanism is uncertain at the time of the power transmission releasing operation, there are problems, such as unnecessary rotation of the motor because of the continuous power transmission releasing operation even though the power transmission mechanism is already in a released-state. This problem results in the occurrence of noise.

Accordingly, the present seatbelt retractor is made in light of the above-described problems. An object of the present application can be to provide an effective technology for increasing the reliability with respect to the power transmission releasing operation of the power transmission mechanism in the seatbelt retractor having a configuration for switching the power transmitting states from the power transmitting state to a power transmission released-state in which the power transmitting state is released and vice versa. The power transmitting state is a state in which the power of the electric motor is transmitted to a spool via a clutch-type power transmission mechanism by rotating the electric motor.

The present seatbelt retractor may help solve the aforementioned problems. The present disclosure may be applicable to a seatbelt retractor mounted on automobiles; however, the present disclosure can also be applied to a structuring technology for a seatbelt retractor mounted on motor vehicles other than the automobile.

### SUMMARY

Accordingly, one of the embodiments of the present invention may be used to solve the aforementioned problems. One embodiment of the present invention may comprise at least a spool, an electric motor, a detection device, a power transmission mechanism, and a control device. The spool retracts and withdraws a seatbelt. The detection device may detect information relevant to a motor load of the electric motor. The power transmission mechanism enables the spool to retract and to withdraw the seatbelt by transmitting the power of the electric motor to the spool. The control device can switch the states of the power transmission mechanism between a power transmitting state wherein the spool rotates and a power transmission released-state wherein the power transmitting state is released by performing a switching operation for rotating the directions of the electric motor. The control device may perform the control operation for the electric motor to rotate in a transmitting state judging mode when the control device performs a power transmission releasing operation. The control device judges the power transmitting state of the power transmission mechanism on the basis of information detected by the detection device when the control device performs the control operation for the electric motor to rotate. When the control device judges the power transmission mechanism to be in a power transmitting state, the control device performs the control operation for the electric motor to rotate in a power transmission releasing direction to release the power transmission. When the control device judges the power transmission mechanism to be in a power transmission released-state, the control device performs the control operation for the power transmission mechanism to keep the power transmission released-state.

The spool of an embodiment of the present invention serves as a member to perform a retracting operation and a withdrawing operation for a seatbelt. The seatbelt being retracted and withdrawn by the seatbelt retractor is a lengthy belt worn by an occupant seated on the motor vehicle seat and is sometimes called a “webbing.” Typically, it is intended to protect the occupant seated on the motor vehicle seat by keeping the occupant under restraint by the seatbelt when the occupant encounters a crash of the motor vehicle.

The detection device may be configured to serve as a device for detecting information relevant to the motor load of the electric motor. Here, the “information relevant to the motor load” may be the motor load per se or the information relevant to the motor load. Typically, the motor load is led by detecting the motor-current value.

The power transmission mechanism can be configured to serve as a mechanism that enables the spool to perform the retracting operation and the withdrawing operation by transmitting the power of the electric motor.

The control device of the present application may perform the control operation for the electric motor to rotate in a power transmission judging mode when a power transmission releasing operation is performed. The control device may also judge a transmitting state of the power transmission mechanism on the basis of the information detected by the detection device when performing the control operation for the electric motor to rotate. In addition, when the control device judges the power transmission mechanism to be in the power transmitting state, the control device performs the control operation for the electric motor to rotate in a direction of a power transmission releasing state so as to release the power transmitting state. When the control device judges that the power transmission mechanism to be in the power transmission released-state, the control device performs the control operation for the power transmission mechanism to keep the power transmission released-state. Furthermore, the power transmitting state of the power transmission mechanism includes one or more transmitting states. Thus, when the power transmission mechanism is in the predetermined state and as a result of the electric motor being controlled to rotate in the power transmission releasing direction, the power transmission mechanism may move into a state in which the predetermined power transmitting state is released and the power transmission per se is released (a state in which the power transmission to the spool is cutoff) or may move into another power transmitting state in which the predetermined power transmitting state is released. The control device is typically configured to include a CPU (Central Processing Unit), an input and output device, a memory device, a peripheral device, and the like.

According to one configuration of the seatbelt retractor of the present application, the control device may judge the transmitting state of the power transmission mechanism when performing the clutch releasing operation. The control device can perform a clutch releasing operation in a desired mode, which is appropriate for the transmitting state of the power transmission mechanism, by starting the clutch releasing operation in a best mode on the basis of the detected result. Thus, the electric motor is prevented from being ordered to rotate when the clutch is already in the state of being turned off (in the state of power transmission cutoff mode) and the noise caused by the unnecessary rotation of the electric motor is prevented.

A second embodiment of the present invention may solve the aforementioned problems, which may comprise at least the spool, the electric motor, the detection device, the power transmission mechanism, and the control device. The spool retracts and withdraws a seatbelt. The detection device may detect information relevant to a motor load of the electric motor. The power transmission mechanism enables the spool to retract and withdraw the seatbelt by transmitting the power of the electric motor to the spool. The control device performs the control operation for the power transmission mechanism to be switched among a first power transmitting state wherein the spool rotates at a relatively high speed and a relatively low torque, a second power transmitting state wherein the spool rotates at a relatively low speed and a relatively high torque, and a power transmission released-state wherein the first and second power transmitting states are released. The control devices release the first power transmitting state by performing the control operation for the electric motor to rotate in a first rotating direction and releases the second transmitting state by performing the control operation for the electric motor to rotate in a second rotating direction being contrary to the first rotating direction. The control device performs the control operation for the electric motor to rotate in a transmitting state judging mode when performing the power transmission releasing operation. Also, the control device judges the transmitting state of the power transmission mechanism on the basis of the information detected by the detection device when the control device performs the control operation for the electric motor to rotate. In addition, when the control device judges the power transmission mechanism to be in the first power transmitting state, the control device performs the control operation for the electric motor to rotate in the first rotating direction. When the control device judges the power transmission mechanism to be in the second power transmitting state, the control device performs the control operation for the electric motor to rotate in the second rotating direction being contrary to the first rotating direction. When the control device judges the power transmission mechanism to be in the power transmission released-state, the control device performs the control operation for the power transmission mechanism to keep the power transmission released-state.

The spool, the electric motor, the detection device, and the power transmission mechanism of this second embodiment may have a similar configuration as that of the spool, the electric motor, the detection device, and the power transmission mechanism of the previous first embodiment.

The control device of the present invention can have a function to switch the states of the power transmission mechanism among a first power transmitting state, a second power transmitting state, and a power transmission cutoff state. The control device releases the first power transmitting state by performing a control operation for the electric motor to rotate in a first rotating direction and releases the second power transmitting state by performing a control operation for the electric motor to rotate in a second rotating direction that is contrary to the first rotating direction. The first power transmitting state is determined to be a state in which the spool rotates in a relatively high speed and at a low torque while the second power transmitting state is determined to be a state in which the spool rotates in a relatively low speed and at a high torque. In addition, regarding the relativity of the speed and the torque of the spool in a case of a comparison between the first power transmitting state and the second power transmitting state, for example, when the first power transmitting state is set to be a benchmark, the spool rotates at a slower speed and higher torque in the second power transmitting state than those in the first power transmitting state. In other words, it can be said that the first power transmitting state is a state in which the spool rotates at a predetermined speed and torque and the second state is a state in which the spool rotates at a speed lower than the predetermined speed in the first power transmitting state and at a torque higher than the predetermined toque in the first power transmitting state. The control device is typically configured to include a CPU (Central Processing Unit), an input and output device, a memory device, a peripheral device, and the like.

In such a seatbelt retractor, because the transmitting state of the power transmission mechanism is uncertain, it is uncertain whether the power transmission mechanism is in the power transmitting state or not Even when it is in the in the power transmitting state, it is uncertain that the power transmitting state is the first power transmitting state or the second power transmitting state.

Therefore, in one of the embodiments of the present invention, the control device may perform a control operation for the electric motor to rotate in the transmitting state judging mode when performing the power transmission releasing operation and may judge the transmitting state of the power transmission mechanism on the basis of information detected by the detection device when performing the control operation for the rotation of the electric motor. The control device performs the control operation for the electric motor to rotate in the first rotating direction when the control device judges the power transmission mechanism to be in the first power transmitting state. In addition, when the control device judges the power transmission mechanism to be in the second power transmitting state, the control device performs the control operation for the electric motor to rotate in the second rotating direction. Also, when the control device judges the power transmission mechanism to be in the power transmission released-state, the control device keeps the power transmission released-state.

According to this embodiment of the seatbelt retractor, the control device may judge the transmitting state of the power transmission mechanism when it performs the power transmission releasing operation. By using the configuration in which the power transmission releasing operation is performed on the basis of the judged result, the reliability of the power transmission mechanism relevant to the power transmission releasing operation is enabled to be increased. In other words, the seatbelt retractor is configured such that only when the power transmission mechanism is in the power transmitting state, the releasing operation is performed and, when the power transmission mechanism is already in the power transmission released-state, the power transmission releasing operation is not performed. Hence, the problem of noise due to the unnecessary rotation of the electric motor relevant to the power transmission releasing operation can be prevented. In addition, the releasing operation can be performed in the desired mode that is appropriate for the current power transmitting state when the power transmission mechanism is in the power transmitting state by configuring the seatbelt retractor to perform the releasing operation after judging whether the power transmitting state is in the first power transmitting state or the second power transmitting state.

Another embodiment the present invention may solve the aforementioned problems, which comprises a power transmission mechanism comprising at least a drive gear at the electric motor side, a driven gear at the spool side, and a driven device intervening between the drive gear and the driven gear. In addition, the driven device transmits a rotating force of the drive gear to the driven gear and is configured to invert the rotating directions (i.e., the rotating direction of the normal rotation or that of the reversed rotation) of the driven gear with respect to each other in the first power transmitting state and in the second power transmitting state when the drive gear rotates in the predetermined direction. The driven device can be configured by appropriately setting the number of components and the disposition after combining the components, such as various kinds of gears and connectors and the like.

According to the seatbelt retractor of this embodiment, the reliability relevant to the power transmission releasing operation of the power transmission mechanism can be increased using the configuration of the power transmission mechanism comprising at least the drive gear at the electric motor side, the driven gear at the spool side, and the driven device intervening between the drive gear and the driven gear.

Yet another embodiment of the present invention that may solve the aforementioned problems is a seatbelt apparatus that comprises at least a seatbelt and a seatbelt retractor, which may be similar to one or more of the previously-mentioned embodiments of the present embodiments.

The seatbelt may be a lengthy belt worn by an occupant seated on a motor vehicle seat and is sometimes called a “webbing.” Typically, it is intended to protect the occupant seated on the motor vehicle seat by keeping the occupant under restraint by the seatbelt when the occupant encounters a crash of the motor vehicle.

According to such a configuration of the seatbelt apparatus, the seatbelt apparatus can have increased reliability relevant to a power transmission releasing operation of the seatbelt retractor.

Another embodiment of the present invention may also solve the aforementioned problems, which can include a motor vehicle having the seatbelt apparatus, which may be similar to the seatbelt apparatus of the previously-mentioned embodiment of the present invention. In this case, the seatbelt apparatus may be stored in a storage space in the motor vehicle, such as the storage space in a pillar, the storage space in a seat, or the storage space in another portion in the motor vehicle.

According to this embodiment, the motor vehicle has a configuration in which the seatbelt apparatus provides increased reliability relevant to the power transmission releasing operation of the seatbelt retractor, which is stored in the storage space in the motor vehicle.

According to various embodiments of the present application, particularly regarding a structure of the seatbelt retractor, an effective technology to increase the reliability relevant to the power transmission releasing operation of the power transmission mechanism can be provided by a configuration in which, when the power transmission releasing operation is performed, the power transmission releasing operation is performed by judging the transmitting state of the power transmission mechanism on the basis of the information of the motor load of the electric motor detected by the detection device.

It is to be understood that both the foregoing general description and the following detailed descriptions are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a drawing illustrating a configuration of a seatbelt apparatus 100 according to one of the embodiments of the present invention.

FIG. 2 is a drawing illustrating a configuration around a seatbelt retractor 1 in FIG. 1.

FIG. 3 is a partially exploded perspective view illustrating a part of the seatbelt retractor 1 according to one embodiment of the present invention.

FIG. 4 is a partially exploded perspective view illustrating the remaining part of the seatbelt retractor according to one embodiment of the seatbelt retractor.

FIG. 5 is a drawing illustrating a state of the seatbelt retractor in which the locking unit, which has a return spring and a base frame as shown in FIGS. 3 and 4, is removed.

FIG. 6 is a drawing illustrating the engagement of a clutch gear 43 and a carrier gear 31 and the engagement of a clutch pawl 49 and ratchet teeth 31c.

FIG. 7 is a drawing explaining a power transmission mode and a power transmission mode switching operation at a power transmission gear mechanism 52 in which FIG. 7(a) is a drawing schematically and partially illustrating a power transmission cutoff mode; FIG. 7(b) is a drawing schematically and partially illustrating a power transmission mode of a low speed-reduction ratio; FIG. 7(c)-(e) are drawings explaining each of the power transmission mode switching operation; and FIG. 7(f) is a drawing schematically and partially illustrating the power transmission mode of a high speed-reduction ratio.

FIG. 8 is a flowchart illustrating the clutch-releasing process of the seatbelt retractor according to one embodiment of the present invention.

### DETAILED DESCRIPTION

Referring now to the drawings, various embodiment of the present invention will be explained in detail.

In addition, if not otherwise specified, “left” and “right” indicate the “left” and “right” directions, respectively, in the drawings referred to in the explanation below. Similarly, “clockwise” and “counterclockwise” indicate the “clockwise” and “counterclockwise” directions, respectively, in the drawings referred to in the explanation below.

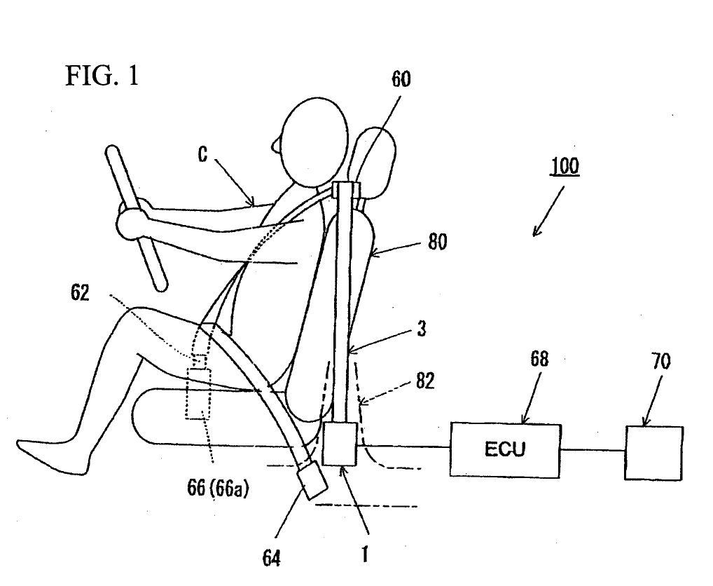

As illustrated in FIG. 1, the seatbelt apparatus 100 of this first embodiment serves as a seatbelt apparatus for use in a motor vehicle. In the case depicted in FIG. 1, the seatbelt apparatus 100 is mounted on an automobile and mainly comprises a seatbelt retractor 1, a seatbelt 3, an ECU 68 (“Electronic Control Unit”), and the like. In addition, an inputting element 70 is mounted on the motor vehicle for detecting various kinds of information and for inputting the detected information into the ECU 68. Such information may include information relevant to the predictability of a crash of the motor vehicle, information relevant to the occurrence of the crash of the motor vehicle, information relevant to a driving state of the motor vehicle, the information relevant to the seated position of an occupant C, information relevant to the physique of the occupant C seated on the seat, information relevant to a surrounding traffic situation, information relevant to the weather and the time zone, and the like. The detected information of the input element 70 may be transmitted to the ECU 68 constantly or at a predetermined time and may be used for performing a controlling operation for the seatbelt apparatus 100.

The seatbelt 3 is a lengthy belt (webbing) used for keeping the occupant C seated on the motor vehicle seat 80 (corresponding to “a seat” in the present application) under restraint or for releasing the occupant C from the restraint. The seatbelt 3 corresponds to “the seatbelt” in the present application. The seatbelt 3 is withdrawn from a seatbelt retractor 1 attached to the motor vehicle, is connected to an out-anchor 64 via a shoulder anchor 60 provided in a shoulder region of the occupant C, and is passed through a tongue 62. The shoulder guide anchor 60 functions to hook and guide the seatbelt 3 in the shoulder region of the occupant C. In addition, the seatbelt 3 is brought to a state to be worn by the occupant C when the tongue 62 is inserted into a buckle 66 attached to the motor vehicle. Furthermore, a buckle switch 66a is embedded in the buckle 66. The buckle switch 66a detects that the tongue 62 is inserted into the buckle 66 (substantially, the seatbelt 3 is brought to a state to be worn by the occupant C).

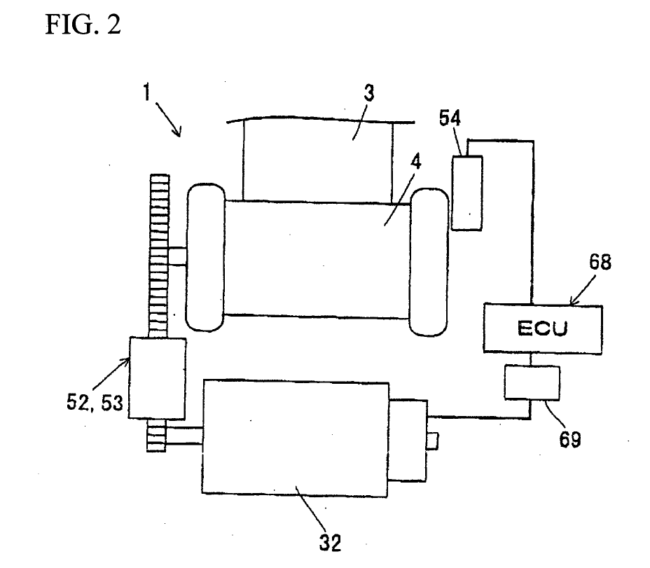

The seatbelt retractor 1, which may correspond to “a seatbelt retractor” of the present disclosure, is an apparatus that enables the seatbelt 3 to be retracted or withdrawn by a spool 4 (shown in FIG. 2), which is to be described later. The retractor 1 can be mounted, for example, on a place in a storage space in a B-pillar 82 of the motor vehicle as shown in FIG. 1.

The ECU 68 may perform the control operations relevant to various operating mechanisms, such as the seatbelt retractor 1 or the like, and may be compose of a CPU (Central Processing Unit), input/output devices, memories, peripheral devices, and the like. Specifically, in the explanation of this embodiment, the ECU 68 performs the control operation relevant to a motor 32 of the seatbelt retractor, to be described later. For example, the ECU 68 controls the amount of electrical current passing through a magnetic coil of the motor 32 and the direction of the passage of electrical current. Accordingly, a rotation speed of a motor shaft or the rotating direction thereof is made variable. The ECU 68 can correspond to a “control device” of the present disclosure.

As shown in FIG. 2, a detecting sensor 54 that directly detects information relevant to a rotation of the spool 4 is mounted on a portion in the seatbelt retractor 1. In this embodiment, the ECU 68 performs the control operation for the motor 32 on the basis of the information detected by the detecting sensor 54. As the information is detected by the detecting sensor 54, the existence or absence of spool rotation, a rotating angle, a rotating direction, a rotating speed, an amount of rotation, and the like can be appropriately used. For the detecting sensor 54, various sorts of sensors can be used, such as a hole sensor, a volume, a photo-interrupter, and the like. In addition, the driving operation of the motor 32 of this embodiment is controlled by the ECU 68 on the basis of an electrical current value of the motor 32 detected by a motor-current detection meter 69. The power of the motor 32 is transmitted to the spool 4 through the power transmission gear mechanism 52 and the power transmission mode switching mechanism 53, which will be described later.

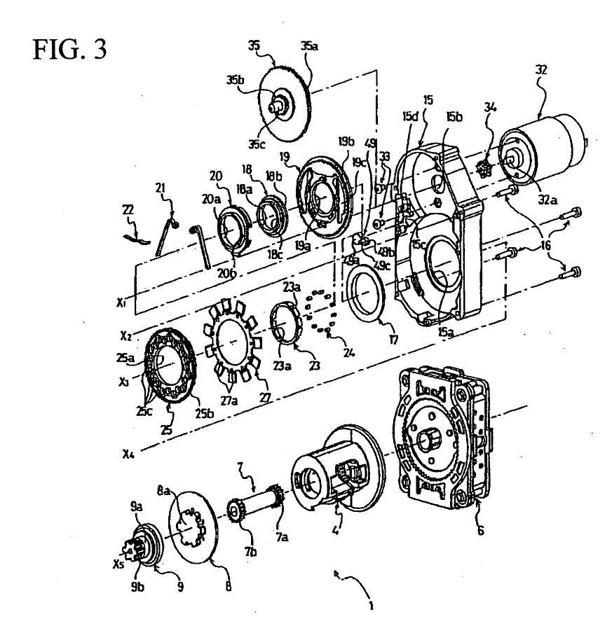

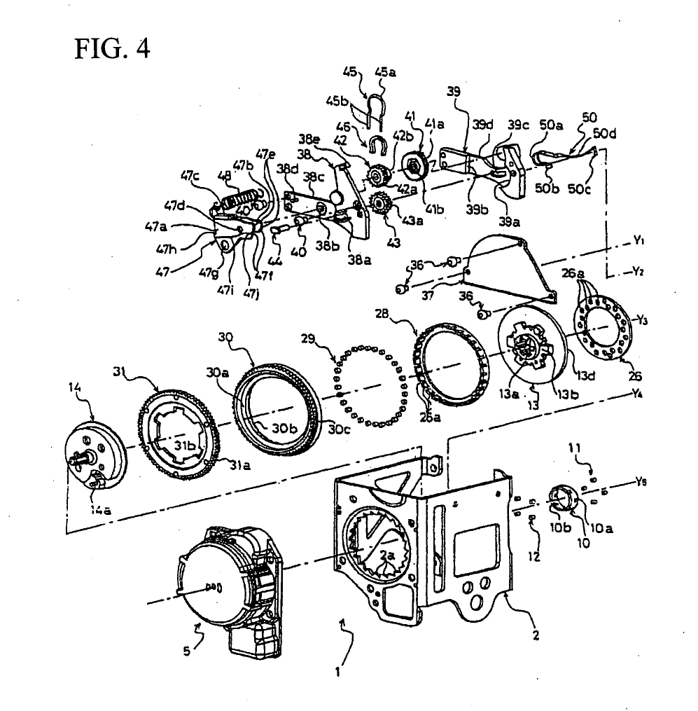

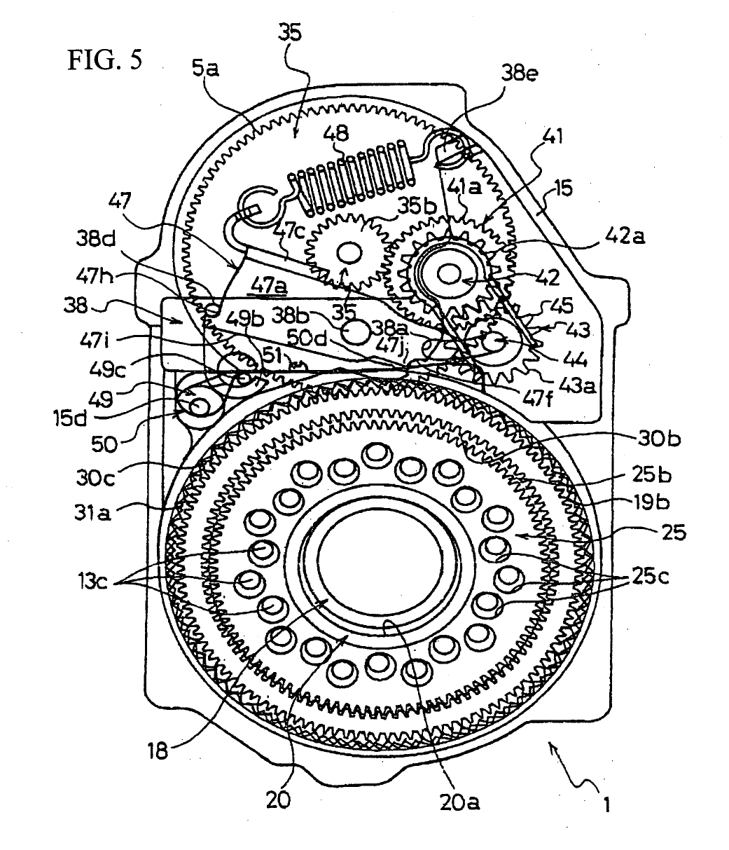

Next, a detailed configuration of an embodiment of the seatbelt retractor 1 will be explained with reference to FIGS. 3 through 5. FIGS. 3 and 4 show partially exploded perspective views illustrating various parts of the seatbelt retractor. FIG. 5 is a drawing illustrating a state of the seatbelt retractor from which a locking unit having the return spring and the base frame from FIGS. 3 and 4 is removed. In addition, the straight alternate long and short dash lines X1, X2, X3, and X4 in FIG. 3 and Y1, Y2, Y3, and Y4 in FIG. 4 are in alignment with each other, respectively.

As shown in FIGS. 3 and 4, the seatbelt retractor 1 is provided with a groove-shaped base frame 2 and spool 4 (rotatably provided in the base frame 2) for retracting the seatbelt 3 to keep the occupant C under restraint. In addition, a locking unit 5 and a spring mechanism, which is provided in the spool 4, are disposed at an outside of one side of the base frame 2. The locking unit has a return spring composed of a locking mechanism that prevents the spool 4 from being rotated in a belt withdrawing direction α by the operation of the locking mechanism. The operation of the locking mechanism is performed when the speed of the motor vehicle is reduced in an amount of more than the predetermined amount of the speed reduction of the motor vehicle caused by the crash of the motor vehicle. The spring mechanism provided in the spool 4 constantly keeps the seatbelt 3 under tension in a belt-retracting direction. As to the above-described locking mechanism and the spring mechanism, known mechanisms can be adopted.

A pre-tensioner 6 is disposed on the outside of the base frame 2 on the opposite side of the locking unit 5 having a return spring. The pre-tensioner 6 is configured to remove the slack of the seatbelt 3 between the spool 4 and the occupant C by retracting the seatbelt 3 (shown in FIGS. 1 and 2) by rotating the spool 4 in a belt-retracting direction β and operates when a high speed-reduction of the motor vehicle occurs.

A torsion bar 7 is provided, which runs through the spool 4 in a concentric manner. One end portion 7a of the torsion bar 7 fits into the spool 4 by a spline-fitting in such a manner so as to be integrally rotatable with the spool 4. The other end portion 7b of the torsion bar 7 fits into a fitting portion (not shown) of a disk-shaped connector 8 by the spline-fitting in such a manner so as to be integrally rotatable with the connector 8. The fitting portion is provided in a concentric manner with the torsion bar 7 at the side of the other end portion 7b of the torsion bar 7 in FIG. 3. At a face of the connector 8 opposite to the side of the torsion bar 7, a spline shaft 8a is disposed in a concentric manner with the torsion bar 7. The spline shaft 8a fits into a spline groove hole (not shown) of a connecting member 9 in such a manner so as to be integrally rotatable with the connecting member 9. The connecting member 9 is provided in a concentric manner with the torsion bar 7 at the side of the spline shaft 8a in FIG. 3.

At a face opposite to a side of the connector 8 of the connecting member 9, a cylindrical portion 9a is disposed in a concentric manner with the torsion bar 7 and a ring-shaped first separator 10 fits into the cylindrical portion 9a. At a plurality of grooves 10a that is disposed at one side of the first separator 10 in the shaft direction, the same number of bearing pins 11 are respectively fit in a rotatable manner (there are four shown the example of FIG. 4). In addition, at a plurality of grooves 10b that is disposed at the other side of the first separator 10 in the shaft direction, the same number of bearing pins 12 are respectively fitted in a rotatable manner (there are four shown in the example of FIG. 4). By means of the bearing pins 11 and 12, the first separator 10 is configured to be relatively rotatable to the cylindrical portion 9a. A spline shaft portion 9b is provided in the connecting member 9, which is continuous to the cylindrical portion 9a, in a concentric manner with the torsion bar 7. The spline shaft portion 9b fits into a spline groove portion 13a provided at an internal face of a ring plate-shaped carrier 13 in a concentric manner with the torsion bar 7. As a result, the connecting member 9 and the carrier 13 are configured to be integrally rotatable.

At a face of the carrier 13 opposite to a side of the torsion bar 7, a spline shaft 13b is provided in a concentric manner with the torsion bar 7. The spline shaft 13b penetrates a spline groove hole 31b, to be described later, in such a manner so as to be integrally rotatable with the spline groove hole 31b of the carrier gear 31. In addition, the spline shaft 13b fits into a spline groove hole (not shown) of a locking base 14 of the locking mechanism of the locking unit 5, which has a return spring in such a manner so as to be integrally rotatable with the spline groove hole. The spline groove hole is provided in a concentric manner with the torsion bar 7 at the side of the spline shaft 13b in FIG. 4. In regard to the locking base 14, known locking bases can be adopted. Also, a pawl 14a rotatably supported by a pawl supporting portion of the locking base 14 engages with a tooth 2a of the base frame 2 by being swung when the locking mechanism is operated. Thus, a rotation of the locking base 14 in a belt withdrawing direction is configured to be prevented. Accordingly, the impact energy received by the occupant C from the seatbelt 3 (shown in FIGS. 1 and 2) caused by inertia is absorbed and eased by a deformation caused by the torsion of the torsion bar 7 when the locking mechanism is operated.

A retainer 15 is attached with four attaching screws 16 to the inside of the opposite side of the base frame 2 where the pre-tensioner 6 is provided. A ring-shaped retainer bearing 17 fits into and attached to a hole 15a of the retainer 15, which has a large diameter. The cylindrical portion 9a of the connecting member 9 is rotatably supported by the retainer bearing 17.

An internal peripheral face 18a of a ring-shaped center member 18 fits into an outer periphery of the first separator 10 by the bearing pins 11 and 12 in a relatively rotatable manner. The center member 18 is attached to a gear 19 because a step portion 18b of the center member 18 is engaged with picks 19a disposed at three positions of the gear 19. Circularly aligned external teeth 19b are formed around the gear 19. A guide portion 19c for movably holding a sun gear 20, to be described later, while guiding the sun gear in a radial direction (the above and below direction as shown in FIG. 3) is provided in the gear 19.

A second peripheral face 18c of the center member 18 fits into a center hole 20a of the ring-shaped sun gear 20. In this case, a diameter of the center hole 20a is set to be greater than that of the second peripheral face 18c. The sun gear 20 is provided in an eccentric manner relative to the second peripheral face 18c, namely, an eccentric manner relative to the external teeth 19b of the gear 19. Furthermore, the sun gear 20 is supported by the guide portion 19c of the gear 19 in a relatively movable manner in a radial direction. Consequently, the center member 18, the gear 19, and the sun gear 20 are configured to be integrally rotatable and the sun gear 20 is provided in such a manner so as to be relatively movable relative to the gear 19 in a radial direction (in the above and below direction in FIG. 3). A pair of springs 21 and a receive spring 22 are provided between the gear 19 and the sun gear 20, thus, the movement of the sun gear 20 relative to the gear 19 in the radial direction is limited by the pair of springs 21.

An outer peripheral face 20b of the sun gear 20 fits into a second separator 23. In this case, a plurality of grooves 23 (there are twelve in the example shown in FIG. 3) is formed in the shaft direction at one side of the second separator 23 and there is a corresponding number of bearing pins 24 that are respectively fitted into the grooves in a rotatable manner. The second separator 23 is configured so as to be rotatable relative to the outer peripheral face 20b of the sun gear 20 by the bearing pins 24. In addition, the second separator 23 fits into a center hole 25a of a circular planet gear 25 in a relatively rotatable manner by the bearing pins 24.

At an outer peripheral face of the planet gear 25, external teeth 25b are formed. Also, at a side face of the planet gear 25, a plurality of holes 25c (for example, twenty two as shown in FIG. 3) that is penetrating the planet gear 25 in the shaft direction is disposed in a zigzag manner in a circumferential direction. In addition, a ring-shaped lifter 26 is sandwiched between the carrier 13 and the planet gear 25. At a side face of the lifter 26, there are holes 26a that have the same number of holes 25c as the planet gear 25 and that penetrate in the shaft direction. These holes 26a are respectively disposed in a zigzag manner in a circumferential direction in such a manner so as to be in alignment with the respective holes 25c. The planet gear 25 and the lifter 26 are provided in such a manner such that projection shafts 13c (shown in FIG. 5), which are protruding in a perpendicularly standing manner from a face of the opposite side of the spline shaft 13b of the carrier 13, fit into the holes 25c and 26a. Thus, the projection shafts being in the shaft direction correspond to the holes 25c and the holes 26a. In this case, a diameter of each of the holes 25c is set to be greater than that of each of the projection shafts 13c as shown in FIG. 5. Thus, each of the projection shafts 13c fits into each of the holes 25c with a clearance therebetween in a movable manner relative to the holes 25c. Also, at a face of the planet gear 25 opposite to the carrier 13 side, a circular speed-reduction plate 27 is provided. The speed-reduction plate 27 is riveted to the carrier 13 by using the holes 27a and the projection shafts 13c of the carrier 13. As a result, the planet gear 25 and the lifter 26 are sandwiched between the carrier 13 and the speed-reduction plate 27. In addition, the planet gear 25 is decentered from a center shaft of the carrier 13, namely a center shaft of the torsion bar 7.

A peripheral face 13d of the carrier 13 fits into a third separator 28. In this case, a plurality of bearing pins 29 having the same number (for example, thirty as shown in FIG. 4) as the plurality of grooves 28a formed at one side of the third separator 28 fit into respective grooves 28a in the shaft direction and in a rotatable manner. The third separator 28 is configured so as to be rotatable relative to the peripheral face 13d of the carrier 13 by the plurality of bearing pins 29. In addition, the third separator 28 fits into a center hole 30a of a circularly shaped internal gear 30 in such a manner so as to be relatively rotatable by the bearing pins 29.

Circularly shaped internal teeth 30b are formed at a center hole 30a of the internal gear 30 at a side of the retainer 15. In addition, when the third separator 28 into which the carrier 13 is fitted fits into the center hole 30a, the planet gear 25 is positioned in the circularly shaped internal teeth 30b in an eccentric manner from the center of the circularly shaped internal teeth 30b. The planet gear 25 is configured such that part of the external teeth 25b of the planet gear 25 are partially engaged with part of the internal teeth 30b. Furthermore, the circularly shaped ratchet teeth 30c are provided at a center hole 30a of the internal gear 30 at a side of the retainer 15.

Adjacent to the internal gear 30 at a side of the locking base 14, a circularly-shaped carrier gear 31 is provided in a concentric manner with the internal gear 30, i.e., in a concentric manner with the torsion bar 7. External teeth 31a are disposed at the peripheral face of the carrier gear 31 and spline groove holes 31b are formed at a center portion of the carrier gear 31. Furthermore, the spline shaft 13b of the carrier 13 penetrates through and engages with the spline shaft hole 31b. Accordingly, the carrier 13 and the carrier gear 31 are able to be integrally rotatable.

A motor 32 that generates rotation torque applied to the spool 4 is attached to an upper position of the pre-tensioner 6 and at an outside of the retainer 15 by means of attaching screws 33. A motor rotation shaft 32a of the motor 32 intrudes into the retainer 15 by penetrating through a penetration hole 15b of the retainer 15. A rotation transmission member 34 is attached to a portion of the motor rotation shaft 32a that is located inside the retainer 15 in such a manner so as to be integrally rotatable. The rotation transmission member 34 fits into a fitting portion (not shown) of a disk-shaped motor gear 35 by means of a spline in such a manner so as to be integrally rotatable. Thus, the fitting portion of the disk-shaped motor gear 35 is concentrically provided on a same shaft as the motor rotation shaft 32a at the side of the rotation transmission member 34 in FIG. 3.

The motor gear 35 is provided with circularly shaped first external teeth 35a that have a relatively large diameter, circularly shaped second external teeth 35b that have a relatively small diameter, and a rotation shaft 35c. The rotation shaft 35c of the motor gear 35 is rotatably supported by a bearing portion of a retainer cover 37 attached to the retainer 15 by attaching screws 36. The bearing portion of the retainer cover 37 is concentrically provided with the rotation shaft 35c at a face of the motor gear 35 side, namely, on the same axis of the motor rotation shaft 32a in FIG. 3). In addition, the first external teeth 35a of the motor gear 35 are engaged with the external teeth 19b of the gear 19 and the second external teeth 35b are engaged with the external teeth 41a of a first connecting gear 41, which is to be described later.

An upper guide plate 38 and a lower guide plate 39 are overlapped with each other and are attached to the retainer 15 with an attaching screw 40. In this case, a predetermined clearance is formed in an intermediate portion between the overlapped upper guide plate 38 and the lower guide plate 39 by step portions 39a and 39b, which are attached to the lower guide plate 39. The first connecting gear 41, a second connecting gear 42, and the clutch gear 43 are provided in the predetermined clearance.

The first connecting gear 41 is provided with external teeth 41a at an outer peripheral face thereof and a hexagonal fitting hole 41b at a center portion thereof. The second connecting gear 42 is provided with external teeth 42a having a diameter smaller than that of the external teeth 41a at an outer peripheral face thereof and a hexagonal fitting shaft 42b at a center thereof. Additionally, the first and second connecting gears 41 and 42 are concentrically combined with each other and are provided with a predetermined clearance in an integrally rotatable manner by fitting the fitting shaft 42b of the second connecting gear 42 into the fitting hole 41b of the first connecting gear 41. The first and second connecting gears 41 and 42 are supported by a rotation shaft (not shown) on the upper guide plate 38 and the lower guide plate 39 in a rotatable manner.

The clutch gear 43 has external teeth 43a having the same diameter as that of the external teeth 42a. The external teeth 42a of the second connecting gear 42 and the external teeth 43a of the clutch gear 43 are engaged with each other. The clutch gear 43 is rotatably supported by the clutch gear shaft 44. Also, the clutch gear shaft 44 is configured so as to be movable along an arc-shaped guide hole 38a provided in the upper guide plate 38 and an arc-shaped guide hole 39c provided in the lower guide plate 39. Both the guide holes 38a and 39c are aligned in the shaft direction and arcs of both the guide holes 38a and 39c are set to be arcs of circles having a common center, which serves as a rotation axis of the first and second connecting gears 41 and 42. As a result, the clutch gear 43 is brought to move around an outer periphery of the second connecting gear 42 while rotating on the clutch gear shaft 44 as a center axis in a state of constantly being engaged with the second connecting gear 42. Furthermore, the clutch gear 43 is configured so as to be engaged with the external teeth 31a of the carrier gear 31 when the clutch gear 43 arrives at a position shown in FIG. 4 by moving around the outer periphery of the second connecting gear 42.

A U-shaped clutch spring 45 is disposed in the clearance between the first and second connecting gears 41 and 42. A curved portion 45a of the clutch spring 45 is supported in a relatively rotatable manner by a protruding shaft (not shown) provided on the second connecting gear 42 in such a manner so as to be protruding toward the first connecting gear 41 in the shaft direction. Thus, the clutch spring 45 is rotatable around the rotational axis of the second connecting gear 42. At this moment, the curved portion 45a is in a state of frictional engagement with the protruding shaft of the second connecting gear 42 at a predetermined frictional force. When the relative rotation force between the clutch spring 45 and the second connecting gear 42 exceeds the predetermined frictional force, the clutch spring 45 is brought into a state of relative rotation by sliding with the second connecting gear 42.

A pair of tip end portions 45b of the clutch spring 45 elastically nips a protruding shaft provided on the clutch gear 43 (not shown) in a protruding manner toward the lower guide plate 39 in the shaft direction. Furthermore, a horseshoe-shaped sliding member 46 formed of resin is provided in between the clutch spring 45 and the second connecting gear 42. The sliding member 46 decreases the abrasion that occurs when the relative sliding operation between the clutch spring 45 and the second connecting gear 42 is performed and makes the sliding operation stable.

In regard to the upper guide plate 38 and the lower guide plate 39, a U-shaped clutch arm is provided, which has two side walls 47a and 47b and a connecting portion 47c for connecting both the side walls 47a and 47b. In this case, the clutch arm 47 is configured in such a manner so as to sandwich the upper guide plate 38 and the lower guide plate 39 with the two side walls 47a and 47b. Supporting shafts respectively protrude on the upper guide plate 38 and the lower guide plate 39 and fit into supporting holes respectively formed in both the side walls 47a and 47b. As a result, the clutch arm 47 is supported on the upper guide plate 38 and the lower guide plate 39 in a relative rotation manner. In FIG. 4, only a supporting hole 47d of the side wall 47a of one side and a supporting shaft 38b of the upper guide 38 are shown and the other components are not shown. However, in the explanation described later, the reference numerals 47d and 38b denote the supporting hole and the supporting shaft, respectively, even though they are not shown.

Further, the clutch gear shaft 44 is capable of contacting each of the right ends 47e of both the side walls 47a and 47b of the clutch arm 47. Additionally, an arc-shaped engaging concave 47f to be engaged with the clutch gear shaft 44 is formed on the right end 47e. Still further, a pawl limiting hole 47g is formed at the side wall 47a of the clutch arm 47. At the left ends of the side walls 47a and 47b, stopper hooking portions 47h are respectively formed. The stopper hooking portions 47h are configured so as to be capable of contacting the stopper shafts provided in the upper guide plate 38 and the lower guide plate 39 when the clutch arm 47 rotates in a clockwise direction. In FIG. 4, only a stopper shaft 38d of the upper guide plate 38 is shown while the stopper shaft of the lower guide plate 39 is not shown. However, in the explanation described later, numeral 38d denotes the stopper shaft of the lower guide plate 39, although it is not shown.

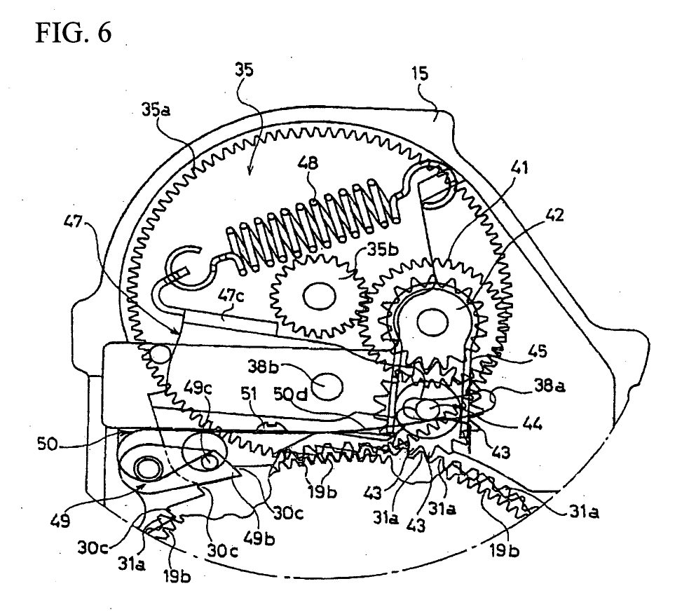

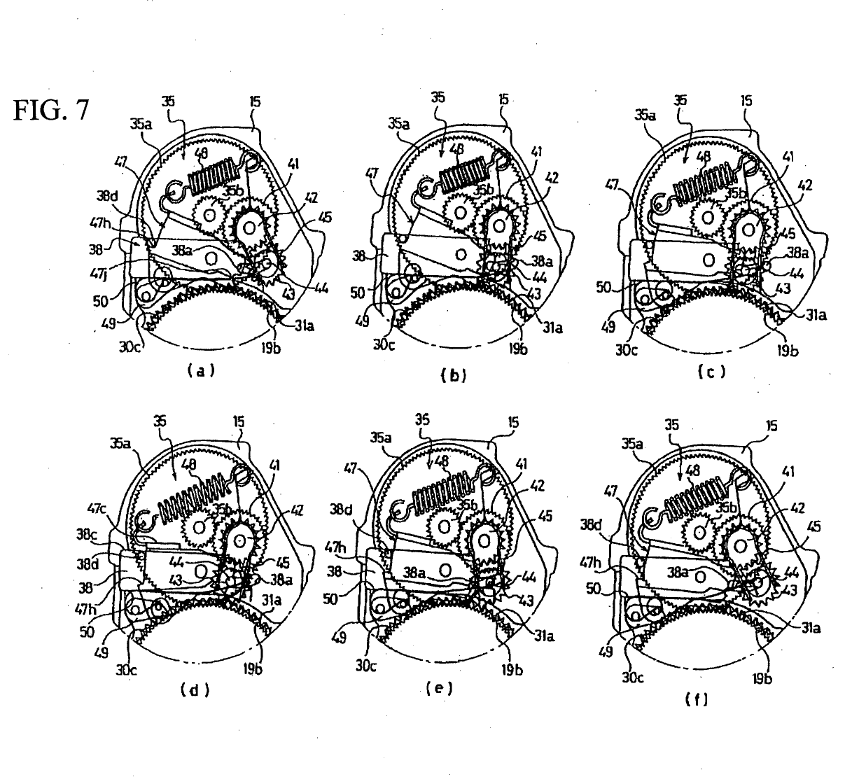

Between the connecting portion 47c of the clutch arm 47 and a spring supporting portion 38e of the upper guide plate 38, a spring 48 is compressed. The clutch arm 47 is constantly biased in such a direction so as to be in a non-operating state as shown in FIG. 5 (the initial state), namely, in a clockwise direction by the spring 48. In addition, in the non-operating state (the initial state) of the clutch arm 47 as shown in FIG. 5, the stopper hooking portion 47h of the clutch arm 47 is held at a position in which the stopper hooking portion 47h is hooked on a stopper shaft 38d by the spring 48. Thus, further rotation of the clutch arm 47 in the clockwise direction is prevented. When the clutch arm 47 rotates in a counterclockwise direction around the supporting shaft of the upper guide plate 38 and the lower guide plate 39 (with the supporting shaft being the rotational center) as shown in FIG. 6, it opposes the biasing force of the spring 48. If the clutch arm 47 continues to rotate in the counterclockwise direction, the connecting portion 47c of the clutch arm 47 may eventually contact each of the top edges 38c and 39d of each of the upper guide plate 38 and the lower guide plate 39 as shown in FIG. 7(d) (which will be described later). Thus, further rotation of the clutch arm 47 in the counterclockwise direction is thereby prevented.

A clutch pawl 49 is rotatably mounted on the retainer 15. In this case, an arc-shaped supporting portion 49a of one end side of the clutch pawl 49 is rotatably supported by an arc-shaped supporting concave portion 15c of the retainer 15. A hooking pick 49b is formed at the other end side of the clutch pawl 49 and the hooking pick 49b is able to be hooked with the ratchet teeth 30c of the internal gear 30 when at a position shown in FIG. 6. In addition, the hooking pick 49b cannot be hooked with the ratchet teeth 30c when at a position shown in FIG. 5. Furthermore, a cylindrically shaped projection shaft 49c is provided in the clutch pawl 49 in which the shaft 49c penetrates a pawl limiting hole 47g of both side walls 47a and 47b. The diameter of the projection shaft 49c is set to be smaller than that of the pawl limiting hole 47g and the projection shaft 49c is configured to be movable within the area of the pawl limiting hole 47g. In other words, the rotation of the clutch pawl 49 is limited by the pawl limiting hole 47g.

Furthermore, a stopper spring 50 is provided in the lower guide plate 39. In this case, as shown in FIG. 5, the stopper spring 50 is attached to the lower guide plate 39 with an attaching screw 51. In addition, an arc-shaped hooking portion 50b positioned at one end side of the stopper spring 50 is hooked by the projection shaft 49c of the clutch pawl 49 and the other end side of the stopper spring 50 is configured to be a guide portion 50c having an angled shape that is angled at approximately 90 degrees. Further, a pressing portion 50d is formed between a supporting portion 50a and the guide portion 50c as shown in FIG. 4.

In the seatbelt retractor 1 assembled in a manner as shown in FIG. 5, when the clutch arm 47 is in a non-operating state, the pressing portion 50d of the stopper spring 50 contacts a corner portion 47j formed at one side wall 47b of the clutch 47. Thereby, the clutch arm 47 is biased in a counterclockwise direction by the pressing portion 50d of the stopper spring 50. In contrast, the position of the stopper spring 50 is limited to the position shown in FIG. 5 by the corner portion 47j of the clutch arm 47.

In the seatbelt retractor 1 of this example, the power transmission gear mechanism 52 for transmitting rotation torque of the motor 32 to the spool 4 may comprise the carrier 13, the center member 18, the gear 19, the sun gear 20, the second separator 23, the planet gear 25, the lifter 26, the third separator 28, the internal gear 30, the carrier gear 31, the motor gear 35, the first connecting gear 41, the second connecting gear 42, the clutch gear 43, the clutch gear shaft 44, and the like.

In addition, the power transmission mode switching mechanism 53 for switching the power transmission modes among three of the power transmission modes (which is to be described later), which is set in the power transmission gear mechanism 52, may comprise the clutch gear 44, the clutch spring 45, the clutch arm 47, the spring 48, the clutch pawl 49, the stopper spring 50, and the like. Furthermore, a speed-reduction mechanism for transmitting a rotation of the motor 32 to the spool 4 in such a manner so as to reduce the speed may comprise the power transmission gear mechanism 52 and the power transmission mode switching mechanism 53. The speed-reduction mechanism or the power transmission gear mechanism 52 can correspond to a power transmission mechanism of the present application.

Next, the three power transmission modes set in the power transmission gear mechanism 52 will be explained.

(1) Power Transmission Cutoff Mode

The power transmission cutoff mode is a mode in which the motor 32 is not driven and the power transmission between the spool and the motor 32 is cutoff. This is a non-operating state, that is to say, an initial state. In the power transmission cutoff mode shown in FIG. 7(a) (FIG. 5 also shows a state in the power transmission cutoff mode), the clutch gear shaft 44 at the power transmission mode switching mechanism 53 is set to a position contacting right ends of guide holes 38a and 39c. The clutch gear 43 is set to a position at which the clutch gear 43 does not engage with the carrier gear 31. As a result, a torque transmission path (a high speed and low torque transmission path, which is described later) between the clutch gear 43 and the carrier gear 31 is cutoff.

The stopper hooking portion 47h of the clutch arm 47 is held at a position in which the stopper hooking portion 47h is hooked on a stopper shaft 38d by the spring 48. In this state of the clutch arm 47, the pressing portion 50d of the stopper spring 50 is in a state of contacting the corner portion 47j of the clutch arm 47. The clutch arm 47 is biased in a counterclockwise direction by the pressing portion 50d and the stopper spring 50 is positioned by the clutch arm 47 in a position shown in FIG. 7(a). The projection shaft 49c of the clutch pawl 49 is pressed by an internal peripheral edge of the pawl limiting hole 47g of the clutch arm 47. Therefore, the hooking pick 49b of the clutch pawl 49 is not engaged with the ratchet teeth 30c of the internal gear 30 and the internal gear 30 is released so as to be freely rotatable. Consequently, the torque transmission path (low speed and high torque transmission path, which is described later) between the motor gear 35 and the carrier 13 is cutoff. Thus, in the power transmission cutoff mode, the spool 4 and the motor 32 are not connected to each other.

(2) Low Speed-Reduction Ratio Power Transmission Mode

The low speed-reduction ratio power transmission mode is a high speed and low torque transmission mode (a high speed mode) in which the motor 32 rotates in a seatbelt retracting direction (the counterclockwise direction) (hereinafter referred to as a “normal rotation”). As shown in FIG. 7(b) and similar to the power transmission cutoff mode, the hooking pick 49b of the clutch pawl 49 is not engaged with the ratchet teeth 30c of the internal gear 30 and the internal gear 30 is released to be freely rotatable. Thus, the low speed and high torque transmission path is cutoff.

However, the clutch gear shaft 44 of the power transmission mode switching mechanism 53 contacts the right end 47e of both side walls 47a and 47b of the clutch arm 47 and the clutch gear 43 is engaged with the carrier gear 31. Accordingly, the clutch gear 43 and the carrier 13 are connected through the carrier gear 31 and the rotation of the motor 32 is transmitted at a reduced speed. Thus, a high speed and low torque transmission path in which the speed-reduction ratio is lower than that of the high speed-reduction ratio power transmission mode (which is to be described later) is set. That is, the motor 32 is connected to the spool 4 via the motor rotation shaft 32a, the rotation transmission member 34, the second external teeth 35b of the motor gear 35, the first connecting gear 41, the second connecting gear 42, the clutch gear 43, the carrier gear 31, the carrier 13, the connecting member 9, the connector 8, and the torsion bar 7. Therefore, the low speed-reduction ratio power transmission mode is set. In the low speed-reduction ratio power transmission mode, the driving force of the motor 32 is transmitted to the spool at a high speed and at a low torque. Thus, the seatbelt 3 can be rapidly retracted.

(3) High Speed-Reduction Ratio Power Transmission Mode

The high speed-reduction ratio power transmission mode is a low speed and high torque transmission mode (a high speed reduction mode means a low speed mode) in which the motor 32 rotates in a reversed direction (the reversed rotation). In the high speed-reduction ratio power transmission mode, the clutch gear 43 is separated from the carrier gear 31 as shown in FIG. 7(e) and the high speed and low torque transmission path is cutoff.

However, the hooking pick 49b of the clutch pawl 49 is engaged with the ratchet teeth 30c of the internal gear 30 (as shown in FIG. 6). The internal gear 30 ceases to be rotated by the torque of the motor 32. Accordingly, the gear 19 and the carrier 13 are connected via the sun gear 20 and the planet gear 25. The rotation of the motor 32 is transmitted to the carrier 13. In this case, the rotation of the motor 32 is converted into a rotation of the planet gear 25 by a planetary mechanism comprising the carrier 13, the sun gear 20, the planet gear 25, and the internal gear 30. As a result, the rotation of the motor 32 is transmitted to the carrier 13 at a highly reduced speed whereby the speed reduction ratio of the rotation is higher than that of the low speed-reduction ratio power transmission mode, as described above. By this configuration, the low speed high torque transmission path is set. That is, the motor 32 is connected to the spool 4 via the motor rotation shaft 32a, the rotation transmission member 34, the first external teeth 35a of the motor gear 35, the gear 19, the sun gear 20, the planet gear 25, the carrier 13, the connecting member 9, the connector 8, and the torsion bar 7. Thus, the high speed-reduction ratio power transmission mode is set. In the high speed-reduction ratio power transmission mode, the driving force of the motor 32 is transmitted to the spool 4 at a low speed and high torque. Thus, the seatbelt 3 can be retracted under a relatively strong or high belt tension.

The switching operation for switching the power transmission modes among the power transmission cutoff mode, the low speed-reduction ratio power transmission mode, and the high speed-reduction ratio power transmission mode is performed by the power transmission mode switching mechanism 53. In this case, the operation of the power transmission mode switching mechanism 53 is performed by the driving force of the motor 32. The driving force of the motor 32 is controlled by the ECU 68 on the basis of a motor-current value detected by the motor-current detection meter 69 as shown in FIG. 2.

(4) Power Transmission Mode Switching Operation from the Cutoff Mode to the Low Speed-Reduction Ratio Power Transmission Mode

When the motor 32 rotates in a direction of the normal rotation from the state of the power transmission cutoff mode as shown in FIG. 7(a), the normal rotation of the motor 32 is transmitted to the motor gear 35, which rotates in a counterclockwise direction. Then, the gear 19 rotates in a clockwise direction at a reduced speed by the counterclockwise rotation of the motor gear 35. At this moment, similar to the power transmission cutoff mode, the hooking pick 49b of the clutch pawl 49 is not engaged with the ratchet teeth 30c. Thus, the internal gear 30 is released to be freely rotatable and the low speed and high torque transmission path is cutoff.

However, the first connecting gear 41 rotates in a clockwise direction at a reduced speed by the counterclockwise rotation of the motor gear 35 via the second external teeth 35b of the motor gear 35. The second connecting gear 42 is also integrally rotated in the same direction as that of the first connecting gear 41 by the rotation thereof. The clutch spring 45 is also integrally rotated in the same direction as the second connecting gear 42 with the rotation shaft of the second connecting gear 42 serving as a rotational center due to the frictional engagement with the protruding shaft (not shown) provided on the second connecting gear 42. Thereby, the clutch gear 43 moves in a direction toward the carrier gear 31. The moving operation of the clutch gear 43 is performed in such a manner such that the clutch gear shaft 44 moves along the guide holes 38a and 39a. In addition, the clutch gear 43 is rotated in a counterclockwise direction due to the rotation of the second connecting gear 42 being in engagement with the clutch gear 43.

As shown in FIG. 7(b), when the clutch gear 43 moves, the clutch gear shaft 44 contacts the right ends 47e of the both side walls 47a and 47b of the clutch arm 47. When the clutch gear shaft 44 contacts the right ends 47e, the movement of the clutch gear shaft 44 and the clutch gear 43 is stopped. At this moment, because the right ends 47e of both side walls 47a and 47b are slanting in a direction from the downward left to the upward right in FIG. 7(b), the clutch gear shaft 44 contacting the right end 47e presses the right end 47e in a direction such that the clutch arm 47 rotates in a counterclockwise direction. However, the force of the clutch gear shaft 44 for pressing the clutch arm 47 is relatively weak at this moment and the torque caused by this force to rotate the clutch arm 47 in the counterclockwise direction is weaker than the torque for rotating the clutch arm 47 in the clockwise direction, which is caused by the spring 48. Thus, the clutch arm 47 is not rotated.

Furthermore, the clutch gear 43 is engaged with the carrier gear 31 at this stopping position. Thus, the power transmission mode switching operation of the power transmission gear mechanism 52 from the power transmission cutoff mode to the low speed-reduction ratio power transmission mode is performed and the power transmission gear mechanism 52 is set to the low speed-reduction ratio power transmission mode.

(5) Power Transmission Mode Switching Operation from the Low Speed-Reduction Ratio Power Transmission Mode to the Power Transmission Cutoff Mode

Conversely, when the power transmission mode is switched from the low speed-reduction ratio power transmission mode shown in FIG. 7(b) to the state of power transmission cutoff mode shown in FIG. 7(a), a rotating direction of the motor 32 is switched from that of the normal rotation to that of the reversed rotation. As a result, the power transmission between the spool 4 and the motor 32 is cut off by operation contrary to the above-described power transmission mode switching operation from the power transmission cutoff mode to the low speed-reduction ratio power transmission mode. The rotating direction of the motor 32 is a controlled direction of the motor rotation for switching the power transmission modes from the low speed-reduction ratio power transmission mode to the power transmission cutoff mode. The rotating direction of the motor 32 corresponds to “a first rotating direction” and “a power transmission releasing direction” of the present disclosure.

(6) Power Transmission Mode Switching Operation from the Low Speed-Reduction Ratio Power Transmission Mode to the High Speed-Reduction Ratio Power Transmission Mode

In the low speed-reduction ratio power transmission mode shown in FIG. 7(b), when the slack of the seatbelt 3 is removed by the rapid retracting operation for retracting the seatbelt 3 by the continuous normal rotation of the motor 32, a belt load as a belt retracting resistance of the spool 4 is increased. Then, the motor-current supplied to the motor 32 is increased by the increase of the belt load resulting in the increase of the rotation torque of the motor 32. As a result, the force of the clutch gear shaft 44 for pressing the clutch arm 47 is increased. When the torque for rotating the clutch arm 47 in the counterclockwise direction caused by the force (as mentioned above) exceeds the torque for rotating the clutch arm 47 in the clockwise direction caused by the spring 48, the clutch arm 47 is rotated in the counterclockwise direction as shown in FIG. 7(c). Then, because the corner portion 47j of the clutch arm 47 moves in an upward direction, i.e., the direction toward which the corner portion 47j separates from the pressing portion 50d of the stopper spring 50, the pressing portion 50d of the stopper spring 50 also moves in the upward direction. In addition, when the pressing portion 50d of the stopper spring 50 contacts the clutch gear shaft 44 as a result of the moving operation of the pressing portion 50d of the stopper spring 50 in the upward direction, the corner portion 47j of the clutch arm 47 is separated from the pressing portion 50d of the stopper spring 50.

Thus, the pressing force of the clutch arm 47 for pressing the projecting portion 49c caused by the spring 48 is made weaker than the pressing force of the pressing portion 49c for pressing the clutch arm 47 in a reversed direction caused by the stopper spring 50. This is because the clutch arm 47 is rotated in the counterclockwise direction. Then, the clutch pawl 49 is rotated in a clockwise direction by the stopper spring 50 whereby the hooking pick 49b is brought to a position to be able to hook onto the ratchet teeth 30c of the internal gear 30. However, when the motor 32 is rotating in the normal rotation, because the internal gear 30 is rotating in the counterclockwise direction, the hooking pick 49b and the ratchet gear 30c are not engaged with each other.

When the clutch arm 47 continues to rotate in the counterclockwise direction, the projecting portion 49c of the clutch pawl 49 is separated from the internal peripheral edge of the pawl limiting hole 47g of the clutch arm 47 as shown in FIG. 7(d). Because the clutch gear shaft 44 contacts the left ends of the guide holes 38a and 38b, the clutch gear shaft 44 stops moving. Then, the rotation of the clutch arm 47 in the counterclockwise direction is stopped and the clutch gear shaft 44 is engaged with the engaging concave 47f.

When the motor-current value detected by the motor-current detection meter 69 exceeds a preset current value, which is a threshold value, the control device stops the rotation of the motor 32 and then rotates the motor in the reversed direction. Then, because the first and the second connecting gears 41 and 42 are rotated in a direction contrary to the above-described direction, i.e., the counterclockwise direction as shown in FIG. 7(e), the internal gear 30 is rotated in the counterclockwise direction and thus, the hooking pick 49b of the clutch pawl 49 is engaged with the ratchet teeth 30c of the internal gear 30. Thereafter, the clutch spring 45 is also rotated in the counterclockwise direction and the clutch gear shaft 44 moves along the guide holes 38a and 39c to be separated from the clutch arm 41 and is separated from the engaging concave 47f. When the clutch gear shaft 44 is separated from the engaging concave 47f, the clutch gear 43 moves in a direction to be separated from the carrier gear 31. Thus, the engagement of the clutch gear 43 with the carrier gear 31 is released. Furthermore, when the clutch gear shaft 44 is separated from the engaging concave 47f, the pressing force for rotating the clutch arm 47 in the counterclockwise direction is weakened. As a result, the clutch arm 47 is rotated in the clockwise direction by the spring 48. Then, the internal peripheral edge of the pawl limiting hole 47g contacts the projection shaft 49c of the clutch pawl 49. At this moment, even when the internal peripheral edge of the pawl limiting hole 47g contacts the projection shaft 49c of the clutch pawl 49, the clutch arm 47 is not further rotated in the clockwise direction and stops at this position. This is because the hooking pick 49b of the clutch pawl 49 is engaged with the ratchet teeth 30c of the internal gear 30.

Thus, the power transmission mode switching operation of the power transmission gear mechanism 52 from the low speed-reduction ratio power transmission mode to the high speed-reduction ratio power transmission mode is performed and the power transmission mode of the power transmission gear mechanism 52 is set to the high speed-reduction ratio power transmission mode. Further, in the high speed-reduction ratio power transmission mode, the clutch gear shaft 44 continues to move and contacts the right ends of the guide holes 38a and 39c and stops, as shown in FIG. 7(f). As a result, the clutch gear shaft 44, the clutch gear 43, and the clutch spring 45 return to the initial position together.

Additionally, the power transmission gear mechanism 52 of this embodiment comprises the gear 19, the sun gear 20, the planet gear 25, the first connecting gear 41, the second connecting gear 42, and a driven device including the clutch gear 43 or the like (which corresponds to a driven device in the present disclosure). The power transmission gear mechanism 52 is located between the motor gear 35 serving as a drive gear of a side of the motor 32 (which constitutes a drive gear in the present application) and the carrier 13 serving as a driven gear of a side of the spool 4 (which constitutes a driven gear in the present application), as described above. The driven device is configured to transmit the rotating force of the motor gear 35 to the carrier 13 and to invert the rotating directions of the carrier 13 between the low speed-reduction ratio power transmission mode and the high speed-reduction ratio power transmission mode when the motor gear 35 rotates in a predetermined rotating direction (a direction of the normal rotation or a direction of the reversed rotation).

(7) Power Transmission Mode Switching Operation from the High Speed-Reduction Ratio Power Transmission Mode (to the Low Speed-Reduction Ratio Power Transmission Mode) to the Power Transmission Cutoff Mode

When the power transmission mode is switched from the high speed-reduction ratio power transmission mode shown in FIG. 7(f) to the power transmission cutoff mode shown in FIG. 7(a), the rotating direction of the motor 32 is first switched from the reversed rotation to the normal rotation. As a result, by operation contrary to the aforementioned power transmission mode switching operation for switching the power transmission modes from the low speed-reduction ratio power transmission mode to the high speed-reduction power transmission mode, the power transmission mode is switched from the high speed-reduction ratio power transmission mode to the low speed-reduction ratio power transmission mode as shown in FIG. 7(b). The rotating direction of the motor 32 is the controlled direction of the motor rotation in which the high speed-reduction ratio power transmission mode is released and the power transmission mode is being transferred (this corresponds to “the second rotating direction contrary to the first rotating direction” and “the power transmission releasing direction” of the present application). In addition, by the further switching of the rotating directions of the motor 32 from that of the low speed-reduction ratio power transmission mode shown in FIG. 7(b), i.e., from normal rotation to the reversed rotation, the power transmission between the spool 4 and the motor 32 is cutoff and the power transmission mode is switched to that of the power transmission cutoff mode shown in FIG. 7(a).

Thus, a setting operation of the power transmission gear mechanism 52 is switched by the rotational control of the motor 32, which is performed by the ECU 68.

In concrete terms, relevant to the low speed-reduction ratio power transmission mode, while the power transmission mode is switched from the power transmission cutoff mode to the low speed-reduction ratio power transmission mode by controlling the rotating direction of the motor 32 to that of the normal rotation and the low speed-reduction ratio power transmission mode is being continued, the power transmission mode is switched from the low speed-reduction ratio power transmission mode to the power transmission cutoff mode by controlling the rotating direction of the motor 32 to that of the reversed rotation whereby the low speed-reduction ratio power transmission mode is released.

Further, relevant to the high speed-reduction ratio power transmission mode, while the low speed-reduction ratio power transmission mode is switched to the high speed-reduction ratio power transmission mode by controlling the rotating direction of the motor 32 to the reversed rotation and the high speed-reduction ratio power transmission mode is being continued, the power transmission mode is switched from the high speed-reduction ratio power transmission mode to the low speed-reduction ratio power transmission mode by controlling the rotating direction of the motor 32 to that of the normal rotation whereby the high speed-reduction ratio power transmission mode is released.

In the seatbelt retractor having a configuration in which the setting of the power transmission gear mechanism 52 is switched by switching the rotating directions of the motor 32, the transmitting state of the power transmission gear mechanism 52 is uncertain when the clutch-releasing operation is performed and thus, a desired direction of the motor 32 to be rotated is uncertain. In such a case, there is a problem in which the desired clutch-releasing operation cannot be performed. Furthermore, for example, even when a clutch is already turned off (power transmission released-state), the motor 32 may be continuously controlled to be rotated and thus, there is a possibility of the unnecessary rotation of the motor 32, which results in occurring noise.

To solve the above-described problems, the ECU 68 may judge the transmitting state when the clutch-releasing operation is performed. The seatbelt retractor 1 of the present application may be configured to start the clutch-releasing operation at a best mode on the basis of the judged result.

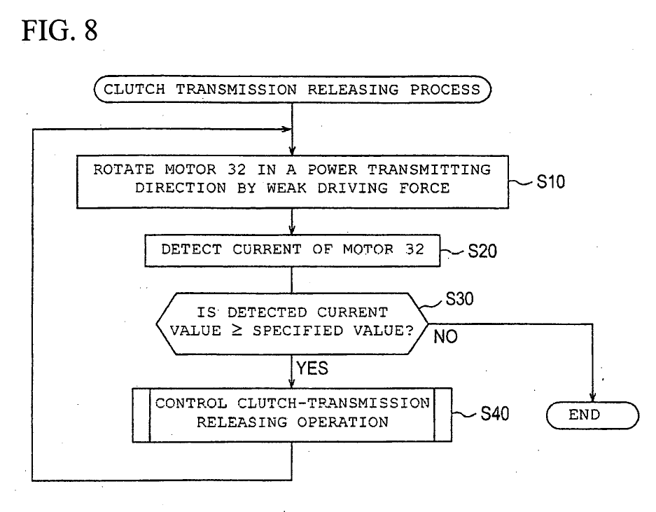

Here, “a clutch-releasing process (power transmission releasing process)” will be explained referring to FIG. 8. The clutch-releasing process may be performed by the ECU 68.

In the clutch-releasing process shown in FIG. 8, the motor 32 is first controlled to be rotated in a mode such that the transmitting state can be judged, i.e., the motor 32 is controlled to be rotated in a mode to be rotated by a weak driving force to an extent such that the transmitting state is not switched as indicated in Step S10. The control operation for the rotation of the motor 32 corresponds to “the control operation for the rotation in a transmitting state judging mode” of the present disclosure.

Next, the motor-current value is detected at a time when the motor 32 is rotated in Step S10 as indicated in Step S20. The motor-current value is detected by the motor-current detection meter 69 as shown in FIG. 2.

The motor-current value detected in Step S20 and the pre-specified value (the threshold value) is compared as indicated in Step S30. In concrete terms, when the motor-current value detected in Step S20 is equal to or greater than the pre-specified value, the ECU 68 judges that a motor load is relatively heavy and the clutch is in a state of being turned on (the low speed-reduction ratio power transmission mode or the high speed-reduction ratio power transmission mode). When the motor-current value is less than the pre-specified value, the ECU 68 judges that the motor load is relatively light and the clutch is in a state of being turned off (the power transmission cutoff mode). That is, the motor-current detection meter 69 is a detection device for detecting information relevant to the motor load of the motor 32, which may correspond to “the detection device” in the present disclosure.

Further, when the ECU 68 judges that the clutch is being turned on (YES, in Step S30), the ECU 68 performs the control operation for a clutch-releasing process in Step S40. When the ECU 68 judges that the clutch is being turned off (NO, in Step S30), the ECU 68 completes the clutch-releasing process and continues the power transmission cutoff mode. In the control operation for the clutch-releasing process in Step S40, the ECU 68 first judges whether the motor-current value detected in Step S20 is a relatively small value corresponding to the low speed-reduction ratio power transmission mode or a relatively large value corresponding to the high speed-reduction ratio power transmission mode. Then, when the ECU 68 judges that the result is the low speed-reduction ratio power transmission mode, the ECU 68 performs the control operation for the motor 32 to rotate in the direction of reversed rotation and performs the releasing operation for the low speed-reduction ratio power transmission mode. When the ECU 68 judges that the result is the high speed-reduction ratio power transmission mode, the ECU 68 performs the control operation for the motor 32 to rotate in the direction of normal rotation and performs the releasing operation for the high speed-reduction ratio power transmission mode.

Thus, the ECU 68 may switch the power transmission gear mechanism 52 among the low speed-reduction ratio power transmission mode, the high speed-reduction ratio power transmission mode, and the power transmission cutoff mode. In addition, the ECU 68 releases the low speed-reduction ratio power transmission mode by performing the control operation for the motor 32 to rotate in the reversed direction and releases the high speed-reduction ratio power transmission mode by performing the control operation for the motor 32 to rotate in the direction of the normal rotation. Furthermore, when the power transmission releasing operation is performed, the ECU 68 performs the control operation for the motor 32 to rotate in the transmitting state judging mode. Additionally, the ECU 68 may judge the transmitting state of the power transmission gear mechanism 52 on the basis of the information detected by the motor-current detection meter 69 at a time when the motor 32 is controlled to be rotated. Moreover, the ECU 68 is configured to perform the control operation for the motor 32 to rotate in the reversed direction when it judges that the power transmission gear mechanism 52 is in the low speed-reduction ratio power transmission mode; to control the motor 32 to rotate in the direction of normal rotation when it judges that the power transmission gear mechanism 52 is in the high speed-reduction ratio power transmission mode; and to maintain the power transmission cutoff mode when it judges that the power transmission gear mechanism 52 is in the power transmission cutoff mode.

By adopting this configured clutch-releasing process, the clutch-releasing operation may be able to perform the desired mode that matches with the transmitting state of the power transmission gear mechanism 52. In addition, for example, the motor 32 can be prevented from being controlled to continue rotation even when the clutch is already in the state of being turned off (in the state of power transmission cutoff mode). Thus, the noise caused by unnecessary rotation of the motor is prevented from occurring.

Now, seven belt modes of the seatbelt 3, which may be set in the seatbelt retractor of the present application, will now be presented. In this case, the setting operation of each of the belt modes may performed by controlling the motor 32 using a motor control device.

(1) Belt Storage Mode

The belt storage mode is a belt mode in which the seatbelt 3 is not used and is completely retracted by the spool 4. In the belt storage mode, the seatbelt retractor 1 is set such that the motor 32 is not rotated and the power transmission gear mechanism 52 is in the power transmission cutoff mode. In addition, the motor 32 has no electric power consumption.

(2) Belt Withdrawal Mode

The belt withdrawal mode is a belt mode in which the seatbelt 3 is withdrawn from the spool 4 so that the occupant C wears the seatbelt 3. Similarly, in the belt withdrawal mode, the seatbelt retractor 1 is set such that the power transmission gear mechanism 52 is in the power transmission cutoff mode. As a result, the seatbelt 3 can be withdrawn by a weak force. Furthermore, the motor 32 is not rotated and the motor 32 also has no electric power consumption.

(3) Belt Retracting Mode for Fitting

The belt retracting mode for fitting is a belt mode in which the excessively withdrawn seatbelt 3 is retracted for fitting on the occupant C after the seatbelt 3 is withdrawn and the tongue is inserted and hooked with the buckle, which causes the buckle switch to be turned on, or in which the withdrawn seatbelt 3 is retracted when the seated occupant C has once moved after being seated in a regular position, which causes the seatbelt 3 to be withdrawn in a predetermined amount and again gets back to be seated in the regular position of the motor vehicle seat where the seatbelt 3 is in a state of normal wearing (at this moment, the buckle switch is in a state of being turned on). In the belt retracting mode for fitting, the seatbelt retractor 1 is set such that the motor 32 is driven in the belt retracting direction and the power transmission gear mechanism 52 is set to the low speed-reduction ratio transmission mode. Accordingly, the seatbelt 3 is rapidly retracted by low torque and is worn by the occupant C in a state of being fitted thereon by stopping the motor 32 when a predetermined slight belt tension force occurs.

(4) Normal Wearing Mode (Comfort Mode)

The normal wearing mode (comfort mode) is a belt mode in the normal wearing state of the seatbelt 3, which is set after the belt retracting mode for fitting is brought to completion. In the normal wearing mode, the seatbelt retractor 1 is set to a state in which the motor 32 is not driven and the power transmission gear mechanism 52 is set to the power transmission cutoff mode. As a result, because only slight belt tension force occurs at the seatbelt 3, the occupant C does not feel the oppression due to wearing of the seatbelt 3. In addition, the motor 32 also has no electric power consumption.

(5) Warning Mode

The warning mode is a belt mode in which the seatbelt retractor 1 repeats the retracting operation of the seatbelt 3 for a predetermined number of times to give a warning to the occupant C when it is detected that the occupant C is dozing while driving the motor vehicle or when an impediment or the like is ahead in the direction of travel of the motor vehicle while in the normal wearing mode. In the warning mode, the seatbelt retractor 1 is configured in such a manner such that the motor 32 is repeatedly driven. Therefore, relatively strong belt tension force (but weaker than the belt tension force of the emergency mode, which is described later) and slight belt tension force of the seatbelt 3 are alternately and repeatedly applied to the occupant C. As a result, the driver is forced to pay attention to his or her dozing off or the impediment that lie ahead in the direction of travel.

(6) Emergency Mode

The emergency mode is a belt mode that is set when there is an enormous possibility that the motor vehicle will collide with an impediment or the like when traveling in the normal wearing mode. The emergency mode may include the following two steps.

(I) Early Stage

At the early stage of the emergency mode, the seatbelt retractor 1 is set in such a manner such that the motor 32 is rotated in the direction of normal rotation. Then, the power transmission gear mechanism 52 is switched from the power transmission cutoff mode to the low speed-reduction ratio power transmission mode. Accordingly, the seatbelt 3 is rapidly retracted at a low torque and the slack of the seatbelt 3 is rapidly removed.

(II) Late Stage

When the slack of the seatbelt 3 is removed at the aforementioned early stage, the emergency mode proceeds to the late stage after being continued from the early stage. At the late stage, the tension force of the seatbelt 3, i.e., the belt load, substantially increases and the motor-current value is thereby increased. When the motor-current value detected by the motor-current detection meter 69 is increased up to a preset current value, the motor 32 rotates in the reversed direction after stopping. Then, the power transmission gear mechanism 52 is switched from the low speed-reduction ratio power transmission mode to the high speed-reduction ratio power transmission mode. Thus, the seatbelt 3 is retracted at a high torque and the occupant C is kept under restraint under extremely strong belt tension.

(7) Belt Retracting Mode for Storage

The belt retracting mode for storage is a belt mode in which when the tongue is pulled out from the buckle and the buckle switch is turned off so as to release the wearing operation of the seatbelt 3, the seatbelt 3 is completely retracted for storage. In the belt retracting mode for storage, because the control device rotates the motor 32 in the direction of normal rotation, the power transmission gear mechanism 52 is set to be in the low speed-reduction ratio power transmission mode. As a result, the withdrawn seatbelt 3 is rapidly retracted by the low torque.

In addition, the motor 32 is stopped when the seatbelt 3 is completely retracted and a predetermined slight belt tension force occurs. The power transmission gear mechanism 52 is switched from the low speed-reduction ratio power transmission mode to the power transmission cutoff mode by the slightly reversed rotation of the motor 32. Thereafter, the motor 32 is stopped and the seatbelt 3 is brought to be in the belt storage mode.

With regard to the belt retracting mode for storage in one embodiment of the present embodiment, the seatbelt retractor 1 can be configured to perform the control operation using a detecting sensor 54 as shown in FIG. 2 in order to increase the reliability relevant to the storing operation of the seatbelt 3 by solving various kinds of problems. Examples of such problems may include that the seatbelt 3 is not stored even when the seatbelt 3 is required to be stored and that the seatbelt is kept in a state of being withdrawn or the storing operation for the seatbelt 3 is started even when the seatbelt 3 is in the middle of being worn by the occupant C and is not required to be stored.

In concrete terms, the control device (for example, the ECU 68 as shown in FIGS. 1 and 2) may judge whether the seatbelt 3 is in an appropriate state to start the storing operation on the basis of information (for example, an existence or absence of the rotating operation, a rotating angle, a rotating direction, a rotating speed, an amount of rotation, or the like) relevant to the rotation of the spool 4 and directly detected by the detecting sensor 54. Then, the ECU 68 performs the control operation for driving the motor 32 in the belt retracting direction when the seatbelt 3 is judged to be in the appropriate state to start the storing operation and starts performing the storing operation for the seatbelt 3. As a condition to starting the storing operation for the seatbelt 3, a “first starting condition for storing” to a “third starting condition for storing,” for example, can be used as discussed below. When at least one of the starting conditions for storing is satisfied, the storing operation for the seatbelt 3 is started. The information of the rotating operation of the spool 4 can be easily detected by detecting the information of the rotating operation of the spool 4 per se by the detecting sensor 54.

As to the first starting condition for storing, it is that state in which it is detected by the detecting sensor 54 that the rotating operation of the spool 4 is stopped after the state of the buckle switch 66a is changed from being turned on to being turned off. The state occurs when the occupant C has performed the releasing operation for the seatbelt 3, the storing operation for the seatbelt 3 has not been performed, and the storing operation for the seatbelt 3 is judged to be appropriate.

Regarding the second starting condition for storing, it is that state in which it is detected that the spool 4 is rotated equal to or more than the specified rotation angle (which is previously determined) while the buckle switch 66a is turned off and the motor 32 has stopped, and that thereafter the rotation of the spool 4 is again stopped. In this case, the state occurs when it is detected that the tongue 62 is not inserted and engaged with the buckle 66 when the occupant C withdraws the seatbelt 3 and the operation is completed. Therefore, the storing operation for the seatbelt 3 is judged to be appropriate.

As to the third starting condition for storing, it is that state in which it is detected that the rotation of the spool 4 is stopped after a closed door of the motor vehicle is opened while the buckle switch 66a is turned off. In this case, the state occurs when the occupant C is getting out of the motor vehicle after performing the releasing operation for the seatbelt 3. Therefore, the storing operation for the seatbelt 3 is judged to be appropriate.

As described above, according to the seatbelt retractor 1 of the present embodiment, the ECU 68 judges the transmitting state when the clutch releasing operation is performed. The clutch releasing operation is then started on the basis of the judged result and is started in the best mode. Therefore, the clutch releasing operation can be performed in the desired mode that matches with the transmitting state of the power transmission gear mechanism 52. For example, the motor 32 is prevented from being controlled to continue rotation even when the clutch is already in the state of being turned off (in the state of the power transmission cutoff mode), and thus the occurrence of noise caused by unnecessary rotation of the motor is prevented.

In one particular embodiment, the power transmission gear mechanism 52 can increase the reliability relevant to the power transmission releasing operation by configuring the power transmission gear mechanism 52 to include at least the drive gear on the motor 32 side, the driven gear on the spool 4 side, and a driven device intervening between the drive gear and the driven gear.

Furthermore, according to one embodiment of the seatbelt retractor 1, the storing operation for the seatbelt 3 is started in the case when at least one of the first to third starting conditions for storing is satisfied. Thus, the reliability of the seatbelt retractor 1 can be increased by solving various problems, such as the seatbelt 3 is not stored in the state of being kept withdrawn or the seatbelt storing operation is started when the occupant C is in the middle of wearing the seatbelt 3. In addition, by setting the first to third starting condition for storing, a highly-detailed setting relevant to the starting condition for the seatbelt storing operation is thought to be possible.

Still further, according to an embodiment of the seatbelt retractor 1, two belt-retracting capabilities can be realized because the power transmission gear mechanism 52 is set to have two power transmission paths, i.e., the low speed-reduction ratio power transmission mode composed of a high speed and low torque power transmission path and the high speed-reduction ratio power transmission mode composed of a low speed and high torque power transmission path. Two belt-retracting capabilities are realized, which include a rapid belt retracting operation for removing the slack of the seatbelt 3 that is performed by the low speed-reduction power transmission mode and a belt retracting operation with high torque for keeping the occupant C under restraint that is performed by the high speed-reduction ratio power transmission mode.

In addition, because the two power transmission paths are set, the rotation torque of the motor 32 can be efficiently transmitted to the spool 4. Thus, these two retracting capabilities can be securely realized within limited power consumption. Specifically, because a belt retracting operation for keeping the occupant C under restraint by high torque is performed by the low speed and high torque power transmission path, the rotation torque of the motor 32 can be a smaller size compared to the conventional seatbelt retractor. As a result, the power consumption of the motor 32 can be decreased and a relatively smaller motor can be used. Thus, the seatbelt retractor 1 can be made compact.

Furthermore, because the aforementioned two retracting capabilities can be realized, a pre-tensioning function according to the rotation torque of the motor 32 can be added to the seatbelt retractor 1. As a result, the pre-tensioner using a reaction gas in the conventional seatbelt retractor is thought to be unnecessary and the manufacturing cost can be reduced.

Also, because the power transmission gear mechanism 52 can be set to the low speed-reduction ratio power transmission mode or the high speed-reduction ratio power transmission mode corresponding to the tension force of the seatbelt 3, the power transmission mode switching operation can be easily performed without controlling the rotation torque of the motor 32.

In addition, the withdrawal of the seatbelt 3, the normal wearing of the seatbelt 3 without feeling the oppression, and the storing operation for the seatbelt 3 at a time of a non-wearing state can be performed without being affected by the motor 32 because the power transmission cutoff mode (in which the rotation torque of the motor 32 is not transmitted to the spool 4) is set by the power transmission gear mechanism 52.

Further, because the storing and retracting operations of the seatbelt 3 are performed by only the rotation torque of the motor 32, the biasing force in the seatbelt retracting direction caused by a retracting device, such as a spiral spring or the like that is constantly applied to the seatbelt 3, can be eliminated or reduced to be extremely small without using an additional module, such as a tension reducer or the like.

In this case, even when the biasing force caused by the retracting device is set to be within the minimum strength, which is necessary for the fitting operation performed when the occupant C wears the seatbelt 3, the storing and retracting operation for the seatbelt 3 can be securely performed by assisting the retracting operation for the seatbelt 3 by transmitting the rotation of the motor 32 to the spool 4 in the low speed-reduction ratio power transmission mode.

Incidentally, when the low speed-reduction ratio power transmission mode and the high speed-reduction ratio power transmission mode are switched without changing the rotating direction of the motor 32, a high-speed transmission clutch mechanism, which switches the transmission mode from the low speed-reduction ratio power transmission mode to the high speed-reduction ratio power transmission mode while accurately correlating with the belt load, is required to stabilize the seatbelt load at a time of the power transmission mode switching operation. In this case, such a high speed transmission clutch mechanism has to adopt a mechanism using a force balance between a member that generates a load correlating with the belt load and the other member that tends to keep the high speed transmission opposed to the aforementioned member. However, such a mechanism has to be generally formed with a combination of a spring load to the member, friction between the members, an action of force between the members, and the like. Accordingly, the balancing relationship of the force is varied by mechanical fluctuation, such as a spring coefficient, a coefficient of friction, an action angle of the force and the like. As a result, the belt load sometimes becomes unstable when the transmission mode is switched. In contrast, because the seatbelt retractor 1 of the present application is configured to switch the power transmission mode between the low speed-reduction ratio power transmission mode and the high speed-reduction ratio power transmission mode by changing the rotating direction of the motor 32, it is easy to control the operation of the power transmission mode switching mechanism 53 for performing the power transmission mode switching operation among the power transmission cutoff mode, the low speed-reduction ratio power transmission mode, and the high speed-reduction ratio power transmission mode. Thus, the structure of the power transmission mode switching mechanism 53 can be simplified. Accordingly, the parameters of the aforementioned mechanical variation and the fluctuations that occur when the power transmission mode is switched can be reduced. Thus, the belt load, which occurs when the power transmission mode is switched, can be stabilized. As a result, the switching operation for the power transmission modes can be more accurately and securely performed.

In addition, in a case when the power transmission mode is switched from the low speed-reduction ratio power transmission mode to the high speed-reduction ratio power transmission mode by changing the rotating direction of the motor 32, the parameters of the variation or the fluctuations that influence the belt load at the time when the power transmission mode is switched can be concentrated on the motor-current value corresponding to the motor torque. This is because the timing for switching the power transmission modes is determined by the motor-current value correlating with the belt load by using an inversion per se of the rotating direction from the normal rotation to the reversed rotation for the switching operation for turning off the low speed-reduction ratio power transmission mode. As a result, the switching operation for the power transmission modes can be more accurately and securely performed.

Further, the low speed and high torque transmission paths can be formed into a compact size. This is because the mechanism for setting the high speed-reduction power transmission mode is configured to have a planetary mechanism comprising the carrier 13, the sun gear 20, the planet gear 25, and the internal gear 30. Accordingly, even when the power transmission gear mechanism 52 is configured to have the low speed-reduction ratio power transmission mode or the high speed-reduction ratio power transmission mode, the seatbelt retractor 1 will not be forced to grow in size.

The present invention is not limited to the above-described embodiment and various kinds of applications or variations are considerable. For example, a description of various embodiments described are also feasible.

In one embodiment, the seatbelt retractor 1 has the power transmission gear mechanism 52, which is set to either one of the low speed-reduction ratio power transmission mode or the high speed-reduction ratio power transmission mode, i.e., a so-called multistage clutch is described. However, another embodiment of the seatbelt retractor can have a so-called single-stage clutch provided with one kind of power transmission mode. In this case, a control device (for example, ECU 68) switches a power transmission mechanism (for example, the power transmission gear mechanism 52) from a power transmitting state in which the spool 4 performs a rotating operation (at a predetermined speed and by a predetermined torque) to a power transmission released-state in which the power transmitting state is released.

In addition, the control device may perform a control operation for the motor 32 to rotate in the transmitting state judging mode and judges the transmitting state of the power transmission mechanism on the basis of the information detected by the motor-current detection meter 69 when performing the power transmission releasing operation. Furthermore, when the control device judges that the power transmission mechanism is in the power transmitting state, the control device may perform a control operation for the motor 32 to rotate in the power transmission releasing direction. Also, when the control device judges that the power transmission mechanism is in the power transmission released-state, the control device may perform a control operation for the power transmission mechanism to keep the power transmission released-state. In addition, according to this configuration of the seatbelt retractor, the motor 32 is prevented from being rotated by the control device even when the clutch is already turned off (the power transmission released-state) and the occurrence of noise due to the unnecessary rotation of the motor 32 is also prevented.

Additionally, in the above-described embodiment, the switching operation for the power transmission modes may performed by inversing the rotating direction of the motor 32 from the normal rotation to the reversed rotation when the motor-current value of the motor 32 exceeds a preset current value, which is a threshold value. However, the switching operation for the power transmission modes may be performed by inversing the rotating direction of the motor 32 from the normal rotation to the reversed rotation when a length of time for which the motor-current value exceeds the preset current value exceeds a set length of time. According to this configured switching operation for the power transmission modes, a failure of the timing for inversing the rotating direction of the motor 32 can be suppressed and the power transmission mode switching operation can be far more accurately performed.

Also, for the power transmission mode switching operation, a mechanism other than the power transmission mode switching mechanism 53 can be used by using the low torque and the high torque of the motor 32; for example, a mechanism such as a solenoid or the like.

More over, the rotation torque of the motor 32 may be constant when the power transmission mode is being switched. However, for each of the belt retracting mode for fitting, the warning mode, the emergency mode, the belt retracting mode for storage, and the like, the rotation torque of the motor 32 can be controlled in a manner to be varied corresponding to each of the belt modes.

In addition, the configuration of the seatbelt retractor 1 may be mounted on a motor vehicle. However, the seatbelt retractor can used in the seatbelt apparatus mounted on a conveyance or other vehicles, such as an automobile, an airplane, a vessel or the like that carries the occupant C and that is able to be preferably utilized the seatbelt retractor 1 for retracting the seatbelt 3 for keeping the occupant under restraint and protecting the same by using a motor.

Furthermore, the seatbelt apparatus of the present application can be utilized for the seatbelt apparatus that efficiently keeps the occupant under restraint and protects the occupant who is carried by conveyances or vehicles, for example, an automobile, an airplane, a vessel or the like by utilizing the rotation torque of the motor and by controlling the retracting force of the spool in an accurate manner.

The priority application, Japanese Application JP 2005-105419, filed on Mar. 31, 2005, including the specification, drawings, claims, and abstract, is incorporated herein by reference in its entirety.

Given the disclosure of the present invention, one versed in the art would appreciate that there may be other embodiments and modifications within the scope and spirit of the invention. Accordingly, all modifications attainable by one versed in the art from the present disclosure within the scope and sprit of the present invention are to be included as further embodiments of the present invention. The scope of the present invention is to be defined as set forth in the following claims.

What is claimed is:

1. A seatbelt retractor comprising:
a spool for retracting and withdrawing a seatbelt;
an electric motor;
a power transmission mechanism for enabling the spool to retract and withdraw the seatbelt by transmitting power of the electric motor to the spool; and
a control device for switching states of the power transmission mechanism between a power transmitting-state wherein the spool rotates and a power transmission released-state, wherein the power transmitting-state is released by switching the rotating directions of the electric motor.

2. The seatbelt retractor according to claim 1, wherein the control device is configured to perform a first control operation for the electric motor to rotate in a transmitting-state judging mode when the control device performs a power transmission releasing operation.

3. The seatbelt retractor according to claim 1, further comprising a detection device for detecting information relevant to a motor load of the electric motor.

4. The seatbelt retractor according to claim 3, wherein the control device is configured to judge the power transmitting-state of the power transmission mechanism on the basis of information detected by the detection device when the control device performs the control operation for the electric motor to rotate.

5. The seatbelt retractor according to claim 1, wherein the control device is configured such that the control device performs the control operation for the electric motor to rotate in a power transmission releasing direction to release the power transmission when the control device judges the power transmission mechanism to be in a power transmitting-state and the control device performs the control operation for the power transmission mechanism to keep the power transmission released-state when the control device judges the power transmission mechanism to be in a power transmission released-state.

6. A seatbelt apparatus comprising:
a seat belt retractor including: a spool for retracting and withdrawing a seatbelt, an electric motor, a power transmission mechanism for enabling the spool to retract and withdraw the seatbelt by transmitting power of the electric motor to the spool; and a control device for switching states of the power transmission mechanism between a power transmitting-state wherein the spool rotates and a power transmission released-state, wherein the power transmitting-state is released by switching the rotating directions of the electric motor; and
a seatbelt connected to the seatbelt retractor for restraining an occupant seated on a motor vehicle seat, wherein the seatbelt retractor is configured to retract and withdraw the seatbelt by using the spool of the seatbelt retractor.

7. A motor vehicle comprising:
a vehicle seat;
a seatbelt apparatus including:
a seat belt retractor including: a spool for retracting and withdrawing a seatbelt, an electric motor, a power transmission mechanism for enabling the spool to retract and withdraw the seatbelt by transmitting power of the electric motor to the spool; and a control device for switching states of the power transmission mechanism between a power transmitting-state wherein the spool rotates and a power transmission released-state, wherein the power transmitting-state is released by switching the rotating directions of the electric motor; and
a seatbelt connected to the seatbelt retractor for restraining an occupant seated on a motor vehicle seat, wherein the seatbelt retractor is configured to retract and withdraw the seatbelt by using the spool of the seatbelt retractor, and a storage space, wherein the seatbelt apparatus is stored in the storage space.

8. The motor vehicle according to claim 7, wherein the storage space is located in the seat.

9. A seatbelt retractor comprising:
a spool for retracting and withdrawing a seatbelt;
an electric motor;
a power transmission mechanism for enabling the spool to retract and withdraw the seatbelt by transmitting power of the electric motor to the spool; and
a control device for performing a control operation for the power transmission mechanism to be switched among a first power transmitting state wherein the spool rotates at a relatively high speed and by relatively low torque, a second power transmitting state wherein the spool rotates at a relatively low speed and by relatively high torque, and a power transmission released-state wherein the first and second power transmitting states are released, and
wherein the control device is configured to release the first power transmitting state by performing the control operation for the electric motor to rotate in a first rotating direction and configured to release the second transmitting state by performing the control operation for the electric motor to rotate in a second rotating direction being contrary to the first rotating direction.

10. The seatbelt retractor according to claim 9, wherein the control device is configured to perform a control operation for the electric motor to rotate in a transmitting state judging mode when performing a power transmission releasing operation.

11. The seatbelt retractor according to claim 9, further comprising a detection device for detecting information relevant to a motor load of the electric motor.

12. The seatbelt retractor according to claim 11, wherein the control device is configured to judge a transmitting state of the power transmission mechanism on the basis of information detected by the detection device when the control device performs the control operation for the electric motor to rotate.

13. The seatbelt retractor according to claim 9, wherein the control device is configured to perform a control operation for the electric motor to rotate in the first rotating direction when the control device judges the power transmission mechanism to be in the first power transmitting state.

14. The seatbelt retractor according to claim 13, wherein the control device is configured to perform a control operation for the electric motor to rotate in the second rotating direction being contrary to the first rotating direction when the control device judges the power transmission mechanism to be in the second power transmitting state.

15. The seatbelt retractor according to claim 9, wherein the control device is configured to perform a control operation for the power transmission mechanism to keep the power transmission released-state when the control device judges the power transmission mechanism to be in the power transmission released-state.

16. The seatbelt retractor according to claim 9, wherein the power transmission mechanism comprises a drive gear at an electric motor side, a driven gear at a spool side, and a driven device intervening between the drive gear and the driven gear.

17. The seatbelt retractor according claim 16, wherein the driven device transmits a rotating force of the drive gear to the driven gear, and wherein the driven gear is configured whereby the rotating directions of the driven gear are configured to be inverted with respect to each other for the first power transmission mode and the second power transmission mode when the drive gear rotates in a predetermined rotating direction.
